(19) United States
(12) Patent Application Publication
(10) Pub. No.: US 2006/0072670 A1
(43) Pub. Date: Apr. 6, 2006

(54) Method for encoding and decoding video signals

(76) Inventors: Seung Wook Park, Sungnam-si (KR); Ji Ho Park, Sungnam-si (KR); Byeong Moo Jeon, Sungnam-si (KR)

Correspondence Address: HARNESS, DICKEY & PIERCE, P.L.C., P.O. BOX 8910, RESTON, VA, 20195, US

(21) Appl. No.: 11/231,888

(22) Filed: Sep. 22, 2005

Related U.S. Application Data
(60) Provisional application No. 60/612,184, filed on Sep. 23, 2004.

(30) Foreign Application Priority Data
Feb. 23, 2005 (KR) 10-2005-0014855

(51) Int. Cl. H04N 11/04; H04N 7/12; H04B 1/66; H04N 11/02

(52) U.S. Cl. 375/240.24

(57) ABSTRACT

In one embodiment of the method of decoding an encoded video signal by inverse motion compensated temporal filtering (MCTF), a first image block of the encoded video signal is selectively subtracted from a second image block of the encoded video signal to obtain a decoded second image block. For example, the first image block may be an image block from a H frame in the encoded video signal, and the second image block may be an image block from a L frame in the encoded video signal.

### DOMESTIC PRIORITY INFORMATION

This application claims priority under 35 U.S.C. §119 on U.S. provisional application 60/612,184, filed Sep. 23, 2004; the entire contents of which are hereby incorporated by reference.

### BACKGROUND OF THE INVENTION

1. Field of the Invention

The present invention relates to a method for encoding and decoding video signals.

2. Description of the Related Art

A number of standards have been suggested for digitizing video signals. One well-known standard is MPEG, which has been adopted for recording movie content, etc., on recording media such as DVDs and is now in widespread use. Another standard is H.264, which is expected to be used as a standard for high-quality TV broadcast signals in the future.

While TV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of variables such as the number of frames transmitted per second, resolution, the number of bits per pixel, etc. This imposes a great burden on content providers.

In view of the above, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, and causes some time delay in providing the requested data to the mobile device. The transcoding procedure also requires complex hardware and algorithms to cope with the wide variety of target encoding formats.

A Scalable Video Codec (SVC) has been developed in an attempt to overcome these problems. This scheme encodes video into a sequence of pictures with the highest image quality while guaranteeing a certain level of image quality of the video when using part of the encoded picture sequence (specifically, a partial sequence of frames intermittently selected from the total sequence of frames).

Motion Compensated Temporal Filtering (MCTF) is an encoding scheme that has been suggested for use in the scalable video codec. However, the MCTF scheme requires a high compression efficiency (i.e., a high coding rate) for reducing the number of bits transmitted per second since it is highly likely that it will be applied to mobile communication where bandwidth is limited, as described above.

In MCTF, which is a Motion Compensation (MC) encoding method, it is important to find overlapping parts (i.e., temporally correlated parts) in a video sequence. As will be described in detail later, MCTF includes prediction and update steps. It is beneficial for the prediction step to generate H frames having small residual errors, which will be described later, and it is beneficial for the update step to concentrate most energy in L frames, which will also be described in detail later, for improving final compression efficiency. This process uniformly distributes compression errors between compressed frames when compressing a video signal into frames, thereby increasing compression efficiency.

However, the update step has a significant problem in that it reduces coding gain (i.e., coding efficiency) if Motion Estimation (ME) and Motion Compensation (MC) operations are not properly performed at the prediction step. Specifically, if an H frame having large residual energy is produced at the prediction step, artifacts occur at the update step, resulting in a reduction in coding efficiency. For example, an H frame having large residual energy is generated if the prediction step is performed on frames in a video frame sequence before and after a flash.

### SUMMARY OF THE INVENTION

The present invention relates to encoding and decoding a video signal by motion compensated temporal filtering.

In one embodiment of the method of decoding an encoded video signal by inverse motion compensated temporal filtering (MCTF), a first image block of the encoded video signal is selectively subtracted from a second image block of the encoded video signal to obtain a decoded second image block. For example, the first image block may be an image block from a H frame in the encoded video signal, and the second image block may be an image block from a L frame in the encoded video signal.

In one embodiment, information indicating whether to subtract the first image block from the second image block is obtained, and the first image block is selectively subtracted from the second image block based on the obtained information.

In another embodiment of a method of decoding an encoded video signal by inverse motion compensated temporal filtering (MCTF), an inverse update operation is selectively performed.

In an embodiment of a method of encoding a video signal by motion compensated temporal filtering (MCTF), a first image block is selectively added to a second image block associated with the first image block.

In a further embodiment of the encoding method, an update operation is selectively performed.

In yet another embodiment of a method of encoding a video signal by motion compensated temporal filtering (MCTF), information is added to the encoded video signal to indicate whether at least one encoded image block in the encoded video signal was obtained by adding an image difference to a image block associated with the image difference.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs video estimation/prediction and update operations in the MCTF encoder shown in FIG. 1;

FIG. 3 illustrates a general 5/3 tap MCTF encoding procedure;

FIG. 4 illustrates two adjacent frames with very different luminance due to a flash at one of the two frames;

FIG. 5 illustrates an MCTF encoding method according to one embodiment of the present invention in which an update operation based on an H frame generated at a prediction step is omitted for every frame in a video frame interval;

FIG. 6 illustrates an MCTF encoding method according to another embodiment of the present invention in which an update operation based on an H frame generated at a prediction step is selectively performed in units of macroblocks or slices;

FIG. 7 is a block diagram of a device for decoding a data stream encoded according to an embodiment of the present invention; and

FIG. 8 is a block diagram of an inverse filter that performs inverse estimation/prediction and update operations in the MCTF decoder shown in FIG. 7.

### DETAILED DESCRIPTION OF EXAMPLE EMBODIMENTS

Example embodiments of the present invention will now be described in detail with reference to the accompanying drawings.

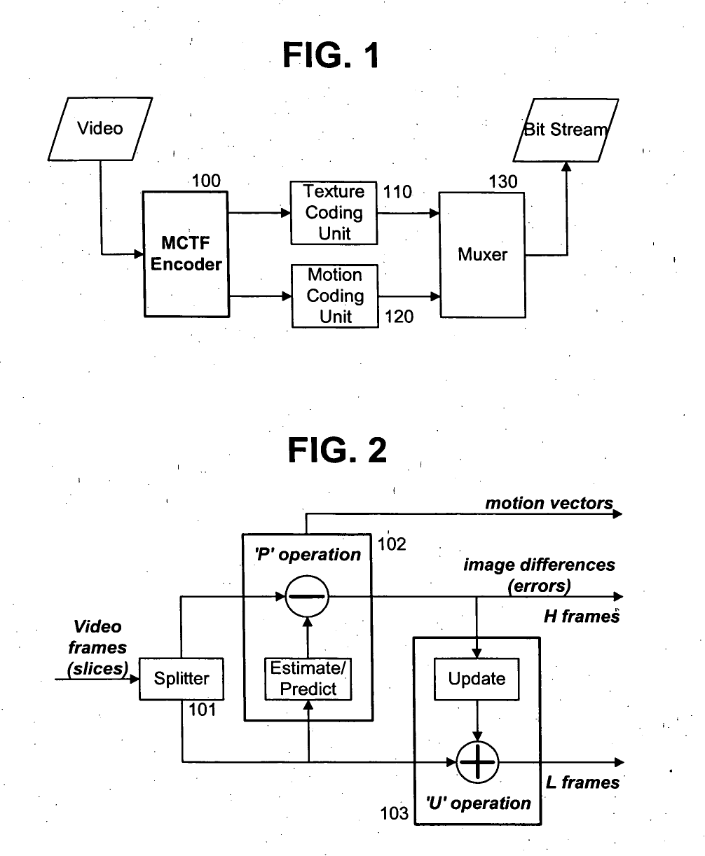

FIG. 1 is a block diagram of a video signal encoding device to which a scalable video signal compression method according to the present invention is applied.

The video signal encoding device shown in FIG. 1 comprises an MCTF encoder 100, a texture coding unit 10, a motion coding unit 120, and a muxer (or multiplexer) 130. The MCTF encoder 100 encodes an input video signal in units of macroblocks according to an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a set format. The muxer 130 multiplexes the encapsulated data into a set transmission format and outputs a data stream.

The MCTF encoder 100 performs prediction operations such as motion estimation and motion compensation operations on each macroblock of a video frame, and also performs an update operation in such a manner that an image difference of the macroblock from a corresponding macroblock in a neighbor frame is added to the corresponding macroblock. FIG. 2 is a block diagram of a filter for carrying out these operations.

As shown in FIG. 2, the filter includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation and/or prediction operations on each macroblock in an arbitrary frame in the frame sequence. As described in more detail below, the estimator/predictor 102 searches for a reference block of each macroblock of the arbitrary frame in neighbor frames prior to and/or subsequent to the arbitrary frame and calculates an image difference (i.e., a pixel-to-pixel difference) of each macroblock from the reference block and a motion vector between each macroblock and the reference block. The updater 103 performs an update operation on a macroblock, whose reference block has been found, by normalizing the calculated image difference of the macroblock from the reference block and adding the normalized difference to the reference block. The operation carried out by the updater 103 is referred to as a ‘U’ operation, and a frame produced by the ‘U’ operation is referred to as an ‘L’ (low) frame.

The filter of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each macroblock, the estimator/predictor 102 searches for a block, whose image is most similar to that of each divided macroblock, in neighbor frames prior to and/or subsequent to the input video frame through MC/ME operations. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame having a threshold image difference sum (or average) or less from a target macroblock in the current frame, a macroblock having the smallest difference (or average) from the target macroblock is referred to as a reference block. For each macroblock of a current frame, two reference blocks may be present in two frames prior to and subsequent to the current frame, or in one frame prior and one frame subsequent to the current frame.

If the reference block is found, the estimator/predictor 102 calculates and outputs a motion vector from the current block to the reference block, and also calculates and outputs differences of pixel values of the current block from pixel values of the reference block, which may be present in either the prior frame or the subsequent frame. Alternatively, the estimator/calculator 102 calculates and outputs differences of pixel values of the current block from average pixel values of two reference blocks, which may be present in the prior and subsequent frames.

Such an operation of the estimator/predictor 102 is referred to as a ‘P’ operation. A frame having an image difference, which the estimator/predictor 102 produces via the P operation, is referred to as an ‘H’ (high) frame since this frame has high frequency components of the video signal.

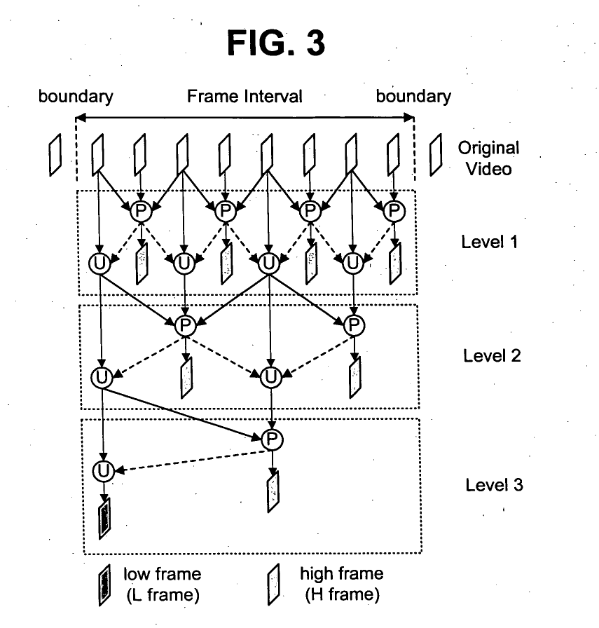

FIG. 3 illustrates a general 5/3 tap MCTF encoding procedure. The general MCTF encoder performs the ‘P’ and ‘U’ operations described above over a plurality of levels in units of specific video frame intervals. Specifically, the general MCTF encoder generates H and L frames of the first level by performing the ‘P’ and ‘U’ operations on a plurality of frames in a current video frame interval, and then generates H and L frames of the second level by repeating the ‘P’ and ‘U’ operations on the generated L frames of the first level via an estimator/predictor and an updater at a next serially-connected level (i.e., the second level) (not shown).

Since all L frames generated at each level are used to generate L and H frames of a next level, only H frames remain at every level other than the last level, where L frame(s) and H frame(s) remain.

The ‘P’ and ‘U’ operations may be repeated up to a level at such that one H frame and one L frame remains. The last level at which the ‘P’ and ‘U’ operations are performed is determined based on the total number of frames in the video frame interval. Alternatively, the MCTF encoder may repeat the ‘P’ and ‘U’ operations up to a level at which two H frames and two L frames remain or up to its previous level.

In the example of FIG. 3, the MCTF encoder performs the ‘P’ and ‘U’ operations over three levels since each video frame interval is composed of 8 (=2³) frames. At the first level, the MCTF encoder generates 4 L frames and 4 H frames from the 8 frames; at the second level, the MCTF encoder generates 2 L frames and 2 H frames from the 4 L frames of the first level; and, at the last (i.e., 3rd) level, the MCTF encoder generates one L frame and one H frame from the 2 L frames of the second level. Consequently, the MCTF encoder generates 4 H frames of the first level, 2 H frames of the second level, and one L frame and one H frame of the third level.

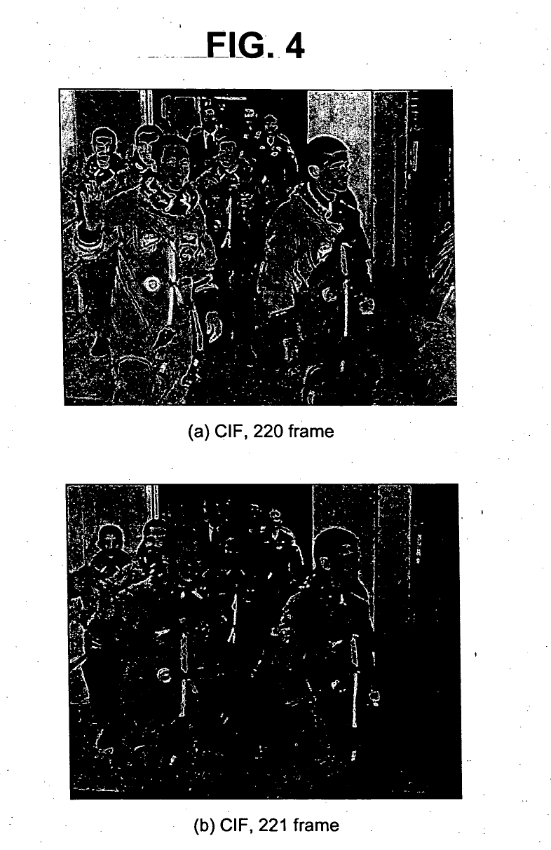

FIG. 4 illustrates two adjacent frames with very different luminance. As described above, if a flash occurs, for example, at a frame as shown in FIG. 4a so that the frame has very different luminance from its adjacent frame as shown in FIG. 4b in the same frame interval, a corresponding H frame generated at the prediction step (i.e., in the ‘P’ operation) has a large residual error. The large residual error of the H frame affects a frame prior to the occurrence of the flash at the update step (in the ‘U’ operation), thereby causing artifacts in its updated L frame.

If the H frame generated at the prediction step has high residual energy, the energy of an L frame, which is generated by the update operation using the H frame, is excessively high. The excessive residual energy is also transferred to the next level, resulting in a reduction in coding efficiency. This means that the ‘U’ operation designed to concentrate energy of each frame in the L frame serves to transfer excessive residual energy of the H frame to the L frame and the next level.

Accordingly, the encoding method according to the present invention selectively performs the update operation (the ‘U’ operation) using H frames so as to prevent high residual energy of the H frames from being transferred to L frames. Specifically, the energy of an H frame generated at the prediction step is compared with a threshold. That is, if the energy of the H frame is higher than the threshold, the update operation using the H frame is not performed. Otherwise, the update operation using the H frame is performed. It will be understood that the energy of the H frame may be determined according to any well-known method.

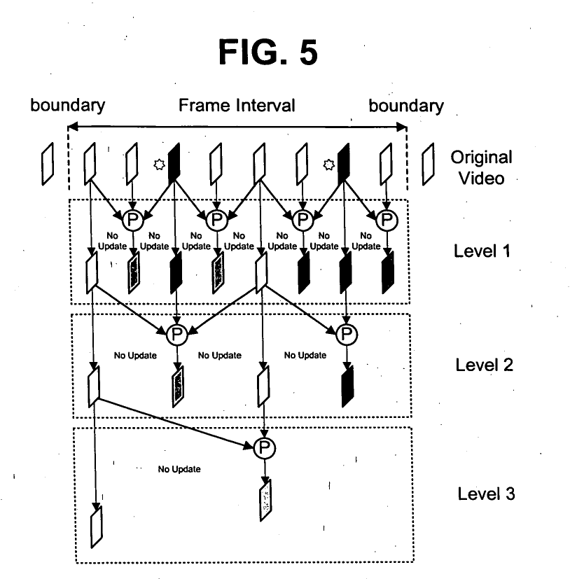

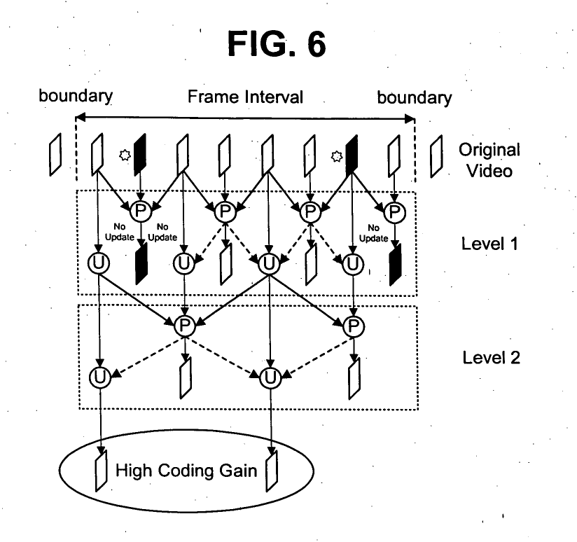

FIGS. 5 and 6 illustrate how an update operation is selectively performed on an original frame or an L frame at a previous level using an H frame generated at a prediction step in an MCTF encoding method according to embodiments of the present invention. FIG. 5 shows an example in which the ‘U’ operation using an H frame is selectively performed in units of video frame intervals. That is, the ‘U’ operation using an H frame is collectively performed or omitted for all frames in each video frame interval. FIG. 6 shows an example in which the ‘U’ operation using an H frame is selectively performed in units of macroblocks or slices. In the example of FIG. 6, the ‘U’ operation is omitted for macroblocks or slices when corresponding H frames have high energy, and the ‘U’ operation is performed for other macroblocks or slices.

If an L frame is generated via the update step using an H frame, an inverse update step using the H frame must be performed when the L and H frames are decoded. If an L frame is generated without performing the update step using an H frame, an inverse update step using the H frame must not be performed when the L and H frames are decoded.

Accordingly, the MCTF encoder needs to inform the decoder of whether or not the ‘U’ operation has been performed in the encoding procedure. Namely, for example, the MCTF encoder needs to inform the decoder of whether to subtract an H frame from an associated L frame. The MCTF encoder 100 according to the present invention records a 1-bit information field (disable update step), which indicates whether or not the ‘U’ operation has been performed, at a specific position of a header area of a group of frames (hereinafter also referred to as a Group Of Picture (GOP)) generated by encoding a video frame interval. Namely, the ‘disable_update_step’ information is added to the encoded video signal, and indicates, for example, whether to subtract an H frame from the associated L frame.

The MCTF encoder 100 according to the present invention deactivates the ‘disable_update_step’ information if the ‘U’ operation has been performed for every frame in the frame interval. Otherwise, the MCTF encoder 100 activates the ‘disable_update_step’ information.

If a frame is divided into a plurality of slices and MCTF encoding is individually performed for each slice, the ‘disable_update_step’ information field may be recorded (e.g., added) in a header area of a corresponding slice layer in the GOP.

If the ‘U’ operation is selectively performed in units of macroblocks, the ‘disable_update_step’ information field may be recorded (e.g., added) in a header area of a corresponding macroblock layer in the GOP.

The data stream encoded in the method described above is transmitted by wire or wirelessly to a decoding device or is delivered via recording media. The decoding device restores the original video signal of the encoded data stream according to the method described below.

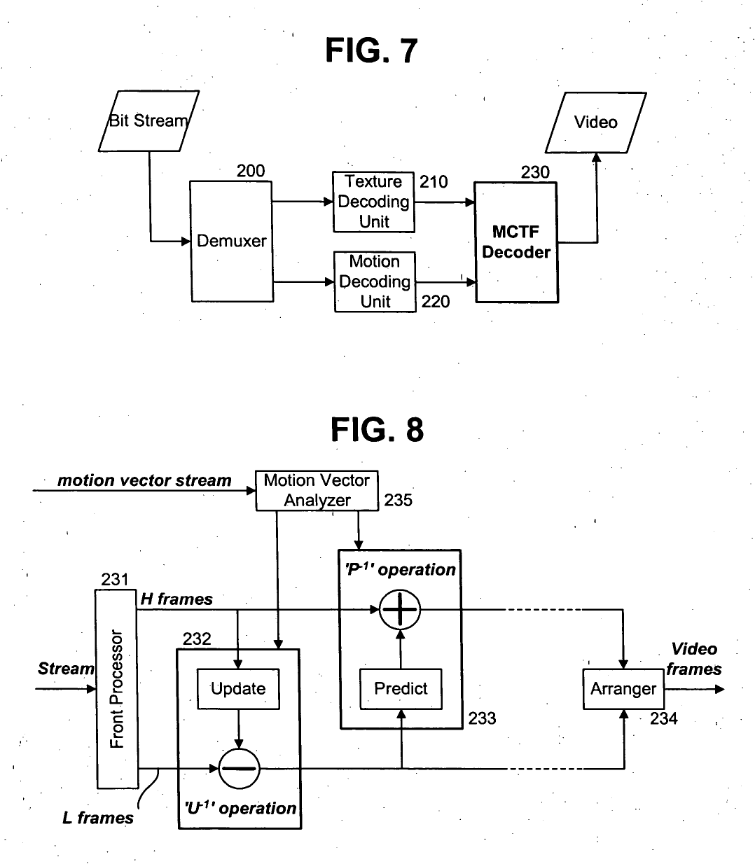

FIG. 7 is a block diagram of a device for decoding a data stream encoded by the device of FIG. 1. The decoding device of FIG. 7 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme.

The MCTF decoder 230 includes, as an internal element, an inverse filter as shown in FIG. 8 for restoring an input stream to its original frame sequence.

The inverse filter of FIG. 8 includes a front processor 231, an inverse updater 232, an inverse predictor 233, an arranger 234, and a motion vector analyzer 235. The front processor 231 divides an input stream into H frames and L frames, and analyzes information in each header in the stream. The inverse updater 232 subtracts differences of input H frames from corresponding pixel values of input L frames. The inverse predictor 233 restores input H frames to frames having original images using the H frames and the L frames from which the image differences of the H frames have been subtracted. The arranger 234 interleaves the frames, completed by the inverse predictor 233, between the L frames output from the inverse updater 232, thereby producing a normal video frame sequence. The motion vector analyzer 235 decodes an input motion vector stream into motion vector information of each block and provides the motion vector information to the inverse updater 232 and the inverse predictor 233. Although one inverse updater 232 and one inverse predictor 233 are illustrated above, a plurality of inverse updaters 232 and a plurality of inverse predictors 233 are provided upstream of the arranger 234 in multiple stages corresponding to the MCTF encoding levels described above.

The front processor 231 analyzes and divides an input stream into an L frame sequence and an H frame sequence. In addition, the front processor 231 uses information in each header in the stream to notify the inverse updater 232 and the inverse predictor 233 of which frame or frames have been used to produce macroblocks in the H frame.

Particularly, the front processor 231 confirms a ‘disable_update_step’ information field included in a header area of a GOP in the stream, in a header area of a slice layer, or in a header area of a macroblock layer in the GOP. If the confirmed ‘disable_update_step’ information field is deactivated, the front processor 231 provides information, which indicates that there is a need to perform an inverse update operation for subtracting an H frame from an L frame, to the inverse updater 232. If the confirmed ‘disable_update_step’ information field is activated, the front processor 231 provides information, which prevents the inverse update operation, to the inverse updater 232.

The inverse updater 232 selectively performs the inverse update operation for subtracting an image difference of an input H frame from an input L frame based on the ‘disable_update_step’ information received from the front processor 232.

Specifically, if the ‘disable_update_step’ information is deactivated, the inverse updater 232 performs the update operation in the following manner. For each macroblock in the input H frame, the inverse updater 232 confirms a reference block present in an L frame prior to or subsequent to the H frame, or two reference blocks present in two L frames prior to and subsequent to the H frame, using a motion vector (or vectors) provided from the motion vector analyzer 235. Then the inverse updater 232 performs the operation of subtracting pixel differences of the macroblock of the input H frame from pixel values of the confirmed one or average of the two reference blocks.

If the ‘disable_update_step’ information is activated, the inverse updater 232 maintains the pixel values of the reference block or blocks of each macroblock in the input H frame without performing the update operation for subtracting the image difference of the input H frame from the input L frame.

The inverse predictor 233 may restore an original image of each macroblock of the input H frame by adding the pixel values of the reference block, from which the image difference of the macroblock has been selectively subtracted in the inverse updater 232, to the pixel differences of the macroblock.

If the ‘disable_update_step’ information is included in a header area of a GOP, the update operation is collectively performed or omitted for all compressed frames in the GOP when the frames are decoded. If the ‘disable_update_step’ information is included in a header area of a slice or a macroblock in the GOP, the update operation is selectively performed for the slice or macroblock according to the ‘disable_update_step’ information.

If the macroblocks of an H frame are restored to their original images by performing the inverse update and prediction operations on the H frame in specific units (for example, in units of frames or slices) in parallel, the restored macroblocks are combined into a single complete video frame.

In another embodiment, instead of directly receiving information about whether to perform the inverse update operation via the ‘disable_update_step’ information field, the MCTF decoder 230 may indirectly determine whether to perform the inverse update operation by comparing information regarding an H frame, for example, energy of the H frame or energy of a slice or macroblock in the H frame with a threshold. When the energy is greater than the threshold, the inverse updating is omitted; otherwise, the inverse updating is performed.

The above decoding method restores an MCTF-encoded data stream to a complete video frame sequence. In the case where the estimation/prediction and update operations have been performed for a video frame interval N times (N levels) in the MCTF encoding procedure described above, a video frame sequence with the original image quality is obtained if the inverse estimation/prediction and update operations are performed N times in the MCTF decoding procedure. However, a video frame sequence with a lower image quality and at a lower bitrate is obtained if the inverse estimation/prediction and update operations are performed less than N times. Accordingly, the decoding device is designed to perform inverse estimation/prediction and update operations to the extent suitable for its performance.

The decoding device described above may be incorporated into a mobile communication terminal or the like or into a media player.

As is apparent from the above description, a method for encoding/decoding video signals according to embodiments of the present invention selectively performs an update operation and an inverse update operation when a video signal is encoded and decoded in a scalable MCTF scheme, thereby reducing the effect excessive energy of a frame may have on other frames during a prediction step and increasing the coding gain.

Although the example embodiments of the present invention have been disclosed for illustrative purposes, those skilled in the art will appreciate that various modifications, additions and substitutions are possible, without departing from the scope and spirit of the invention.

1. A method of decoding an encoded video signal by inverse motion compensated temporal filtering (MCTF), comprising:
selectively subtracting a first image block of the encoded video signal from a second image block of the encoded video signal to obtain a decoded second image block.

2. The method of claim 1, further comprising:
adding the first image block and the decoded second image block.

3. The method of claim 2, wherein the first image block represents an image difference.

4. The method of claim 1, wherein the first image block represents an image difference.

5. The method of claim 1, further comprising:
obtaining the second image block from at least one of the frames neighboring a frame including the first image block.

6. The method of claim 5, wherein the first image block represents an image difference

7. The method of claim 1, wherein the first image block is an image block from a H frame in the encoded video signal.

8. The method of claim 7, wherein the second image block is an image block from a L frame in the encoded video signal.

9. The method of claim 1, wherein the second image block is an image block from a L frame in the encoded video signal.

10. The method of claim 1, further comprising:
obtaining information indicating whether to subtract the first image block from the second image block; and wherein
the selectively subtracting step selectively subtracts the first image block from the second image block based on the obtained information.

11. The method of claim 10, wherein the information is deactivated if the first image block was added to an image block to produce the second image block, and the information is activated if the first image block was not added to the image block to produce the second image block.

12. The method of claim 10, wherein the information indicating whether to subtract the first image block is provided in units of frame intervals.

13. The method of claim 10, wherein the information indicates whether to subtract the first image blocks in a frame interval from respective second image blocks.

14. The method of claim 13, wherein the obtaining step obtains the information from a header area of the frame interval.

15. The method of claim 10, wherein the information indicating whether to subtract the first image block is provided in units of slices.

16. The method of claim 10, wherein the information indicates whether to subtract the first image blocks in a slice from respective second image blocks.

17. The method according to claim 16, wherein the obtaining step obtains the information from a header area of the slice.

18. The method according to claim 10, wherein the information indicating whether to subtract the first image block is provided in units of image blocks.

19. The method according to claim 18, wherein the obtaining step obtains the information from a header area of the second image block.

20. A method of decoding an encoded video signal by inverse motion compensated temporal filtering (MCTF), comprising:
selectively performing an inverse update operation.

21. A method of encoding a video signal by motion compensated temporal filtering (MCTF), comprising:
selectively adding a first image block to a second image block associated with the first image block.

22. The method of claim 21, wherein the first image block is an image difference.

23. The method of claim 21, wherein the selectively adding step is performed based on an energy level of the image difference.

24. A method of encoding a video signal by motion compensated temporal filtering (MCTF), comprising:
selectively performing an update operation.

25. A method of encoding a video signal by motion compensated temporal filtering (MCTF), comprising:
adding information to the encoded video signal indicating whether at least one encoded image block in the encoded video signal was obtained by adding an image difference to a image block associated with the image difference.
